(19) United States
(12) Patent Application Publication
(10) Pub. No.: US 2016/0014960 A1
(43) Pub. Date: Jan. 21, 2016

(54) Moisture Control System For An Agricultural Harvester

(71) Applicant: CNH INDUSTRIAL AMERICA LLC, New Holland, PA (US)

(72) Inventors: Paula J. Meagher, Lititz, PA (US); Michael John Minnich, Elizabethtown, PA (US); Dominick B. Rizzon, Leola, PA (US); Michele Monzio Compagnoni, Sorengo (CH); Jesse H. Orsborn, Warsaw, MO (US)

(21) Appl. No.: 14/771,353

(22) PCT Filed: Feb. 28, 2014
(86) PCT No.: PCT/US14/19588

§ 371 Date: Aug. 28, 2015

Related U.S. Application Data
(60) Provisional application No. 61/770,847, filed on Feb. 28, 2013.

(51) Int. Cl. A01D 41/127

(52) U.S. Cl. CPC A01D 41/127

(57) ABSTRACT

An agricultural moistener system includes a sensor and a controller. The sensor is configured to provide a feedback signal based at least in part on a sensed moisture about a harvester, a sensed accretion of an agricultural product within the harvester, or any combination thereof. The controller is configured to receive the feedback signal and to control application of a solution to one or more spindles based at least in part on the feedback signal. The solution is configured to reduce a first accretion of the agricultural product about the one or more spindles, a second accretion of the agricultural product in an outlet of the harvester, or any combination thereof. The one or more spindles is configured to harvest the agricultural product from a field, and the outlet is configured to receive the agricultural product from the one or more spindles.

This application is the US National Stage filing of International Application Serial No. PCT/US2014/019588 filed on Feb. 28, 2014 which claims priority to U.S. Provisional Application No. 61/770,847 filed Feb. 28, 2013, each of which is incorporated herein by reference in its entirety.

### BACKGROUND

The invention relates generally to ground working equipment, such as agricultural equipment, and more specifically, to a moisture control system for an agricultural harvester.

Generally, harvesters include multiple drums distributed across the width of the harvester. Each drum is configured to harvest crops along a row as the harvester proceeds across a field. Components (e.g., spindles, blades, etc.) of the harvester remove portions of the crop for processing within the harvester as agricultural product. For example, a drum of a cotton harvester may include a rotor with spindles that revolve about the rotor to remove cotton bolls from cotton plants. In certain configurations, the agricultural product may be separated by the harvester into harvested goods (e.g., cotton) and other agricultural materials (e.g., chaff, foliage). The harvested goods and other agricultural materials may be directed through outlets to a bin, baler, or to the field. Unfortunately, too much moisture in the agricultural product may cause the agricultural product to accrete in an outlet to the bin, baler, or to the field, thereby at least partially blocking distribution of the agricultural product. Too little moisture in the agricultural product may cause the agricultural product to accrete (e.g., wind) about the components, thereby reducing the efficiency of the harvester.

### BRIEF DESCRIPTION

In a first embodiment, an agricultural moistener system includes a sensor and a controller. The sensor is configured to provide a feedback signal based at least in part on a sensed moisture about a harvester, a sensed accretion of an agricultural product within the harvester, or any combination thereof. The controller is configured to receive the feedback signal and to control application of a solution to one or more spindles based at least in part on the feedback signal. The solution is configured to reduce a first accretion of the agricultural product about the one or more spindles, a second accretion of the agricultural product in an outlet of the harvester, or any combination thereof. The one or more spindles is configured to harvest the agricultural product from a field, and the outlet is configured to receive the agricultural product from the one or more spindles.

In another embodiment, an agricultural moistener system includes a sensor, a mixing portion, and a controller. The sensor is configured to provide a feedback signal based at least in part on a sensed moisture about a harvester, a sensed accretion of an agricultural product within the harvester, or any combination thereof. The mixing portion is configured to receive a first liquid and a second liquid, and to dispense a solution comprising a first portion of the first liquid and a second portion of the second liquid. The controller is configured to receive the feedback signal and to control dispensation of the solution based at least in part on the feedback signal. The solution is configured to reduce a first accretion of a harvested good of the agricultural product about one or more spindles of a harvester, a second accretion of the agricultural product in an outlet of the harvester, or any combination thereof. The one or more spindles is configured to harvest the agricultural product from a field, and the outlet is configured to receive the agricultural product from the one or more spindles.

In another embodiment, a harvester system includes a rotor having a plurality of spindles and a moistener system. The moistener system includes a sensor configured to provide a feedback signal based at least in part on a sensed moisture of an agricultural product, a sensed accretion of the agricultural product, or any combination thereof. The moistener system also includes a plurality of moistener pads configured to apply a solution to the plurality of spindles. The moistener system also includes a controller configured to receive the feedback signal and to control application of the solution to the plurality of moistener pads based at least in part on the feedback signal. The solution is configured to reduce an accretion of the agricultural product. The plurality of spindles is configured to revolve about the rotor and to move through a plurality of zones. The plurality of zones includes a picking zone, a doffing zone, and a cleaning zone. In the picking zone, the plurality of spindles is configured to harvest the agricultural product. In the doffing zone, the plurality of spindles is configured to discharge a portion of the agricultural product into an outlet. In the cleaning zone, the moistener system is configured to apply the solution to the plurality of spindles.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a harvester configured to harvest rows of a crop;

FIG. 2 is a perspective view of an embodiment of a drum of the harvester of FIG. 1;

FIG. 3 is a cross-section of the drum of FIG. 2, taken along line 3-3; and

FIG. 4 is a block diagram of an embodiment of a drum of the harvester of FIG. 1, having a controller coupled to a moistener system.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

A moistener system of a harvester applies a cleaning solution to clean harvesting components (e.g., spindles, blades). The harvester removes portions of a crop for processing as agricultural product, and separates portions of the agricultural product into outlets, such as a harvested good outlet and a discharge outlet. Portions of the agricultural product may accrete on the harvesting components or in the outlets. The moisture of the crop may affect the accretions. A controller may control the moistener system based at least in part on feedback signals from one or more sensors to control the application of the cleaning solution. By controlling the quantity and/or the composition of the applied cleaning solution, the controller may reduce the accretions on the harvesting components and the accretions in the outlets. One or more sensors coupled to the controller may sense moisture at various locations of the harvester, thereby enabling the controller to determine if conditions of the crop are favorable for accretions (e.g., too dry, too moist, high sap content). One or more sensors coupled to the controller may be optical sensors that sense changes in optical properties (e.g., color, brightness, emissivity, reflectivity, optical obstruction of sensor) of components within the harvester that are proximate to the one or more optical sensors.

The controller receives feedback signals from the one or more sensors and determines a moisture level and/or an accretion at a location within the harvester. The controller controls the quantity and/or composition of the cleaning solution automatically based at least in part on the feedback signals to reduce the accretions about the harvesting components and the accretions in the outlets. Accordingly, the controller may increase the efficiency of the harvester by reducing accretions that may otherwise partially block outlets or wind around the harvesting components (e.g., spindles). The controller may increase a utilization efficiency of the cleaning solution and reduce excess cleaning solution applied to the harvesting components. Utilizing the appropriate amount of the cleaning solution may reduce the level of accretions about the spindles and in the outlets while extending the time between subsequent cleaning solution refills. Utilizing the appropriate amount of the cleaning solution may reduce the moisture added to the agricultural product and/or reduce wear on the harvester.

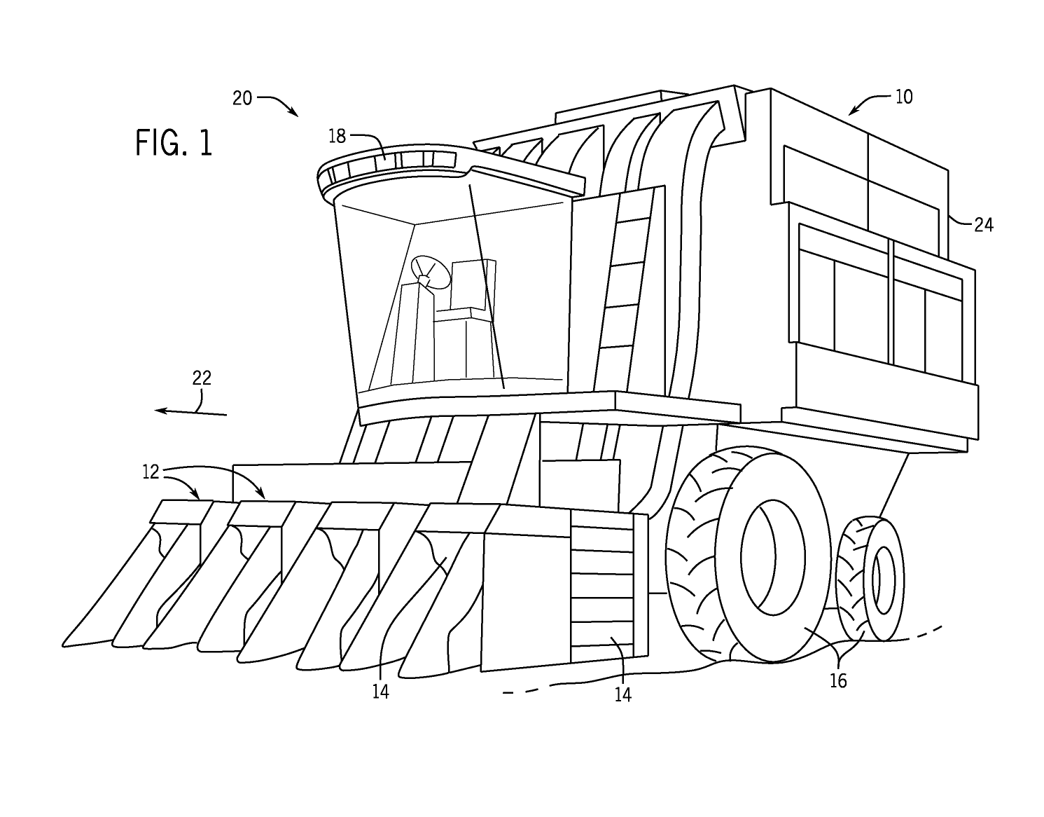

Turning now to the drawings, FIG. 1 is a perspective view of an embodiment of a harvester 10 configured to harvest rows of a crop. The harvester 10 includes drums 12 (e.g., harvesting heads) that utilize a moistener system. The harvester 10 may harvest crops, such as cotton, with one or more rotors 14 in each drum 12. In some embodiments, the harvester 10 may be self-propelled and may move the drums 12 through a field using wheels 16 or tracks. In some embodiments, the drums 12 are an implement driven through the field with a prime mover (e.g., tractor). A cab 18 includes an interface with controls for operating the harvester 10 and for monitoring the harvesting process. In some embodiments, controls in the cab 18 enable the operator to turn the moistener system on or off, to purge the moistener system, to manually control the moistener system, and/or to engage automatic control of the moistener system based at least in part on feedback signals from one or more sensors. Displays and/or indicators in the cab 18 may provide feedback to the operator regarding the moisture of the crop in the field, the moisture of a portion of the agricultural product in the harvester (e.g., harvested good, other agricultural materials), and/or the humidity of an external environment 20.

The drums 12 extend from the harvester 10 substantially parallel to a direction of travel 22 across the field. The drums 12 remove portions of the crops of each row and transfer harvested goods (e.g., cotton) to a bin 24, basket, or baler positioned behind the drums 12. Other agricultural materials (e.g., foliage, stems, debris, detritus) may be deposited through an outlet onto the field beneath and/or behind the harvester 10. In some embodiments, displays and/or indicators in the cab 18 may provide feedback to the operator regarding an accretion of agricultural product about the rotors 14, a level of the harvested good (e.g., cotton) in the bin 24, an outlet or conveyor to the bin, and/or an accretion of other agricultural materials in an outlet. As discussed herein, the term bin 24 may include, but is not limited to, a basket, baler, reservoir, or receptacle to receive the harvested good. The bin 24 may be the part of the harvester 10, a part of a separate implement, or another vehicle.

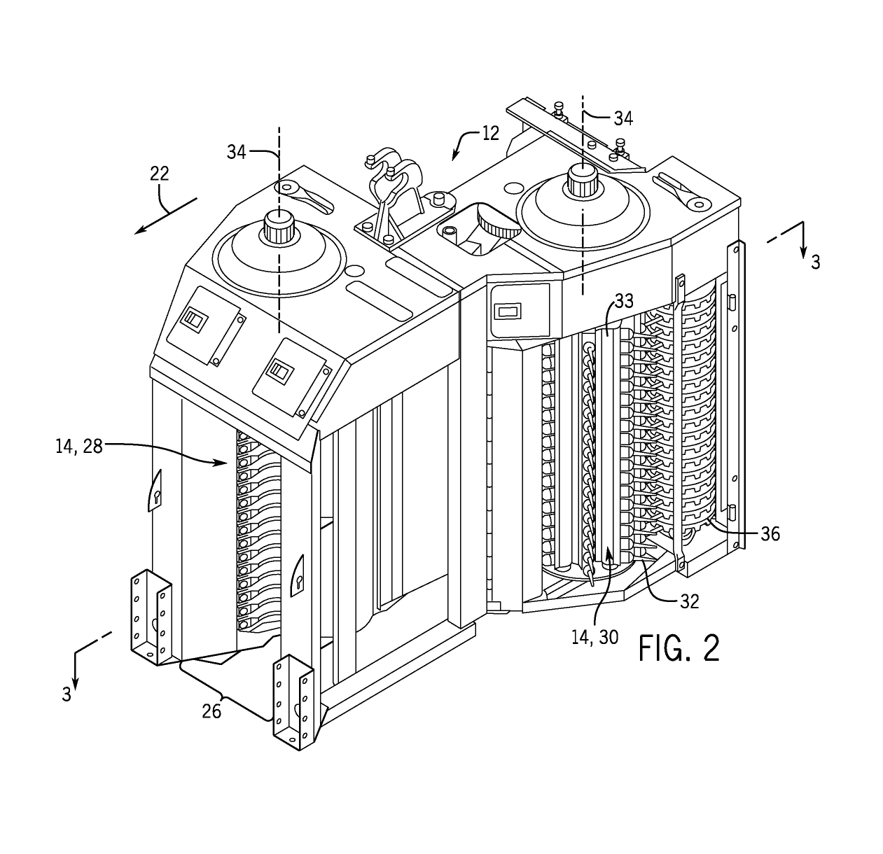

FIG. 2 is a perspective view of an embodiment of the drum 12 of the harvester 10. As the harvester 10 moves in the direction of travel 22, crops enter a crop passage 26 of the drum 12. In some embodiments, the drum 12 has a front rotor 28 and a rear rotor 30 that may be on the same or opposite sides of the crop passage 26. Spindles 32 on spindle bars 33 revolve about an axis 34 of the rotor 14 (e.g., along a cam path) to remove portions of the crops as agricultural product. Doffers 36 transfer the harvested goods (e.g., cotton) of the agricultural product from the rotors 14 to the bin 24. Each spindle bar 33 may have a column of spindles 32 along the axis 34. For example, each spindle bar 33 may have approximately 5 to 50, approximately 10 to 40, or approximately 15 to 30 spindles 32.

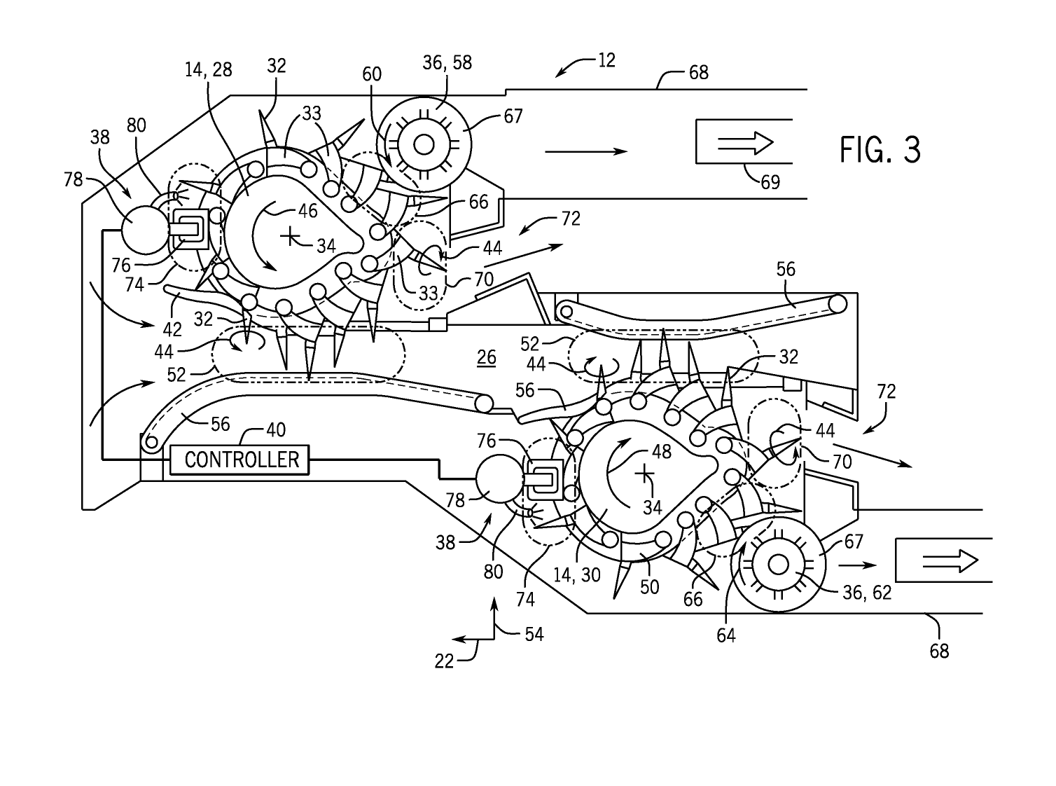

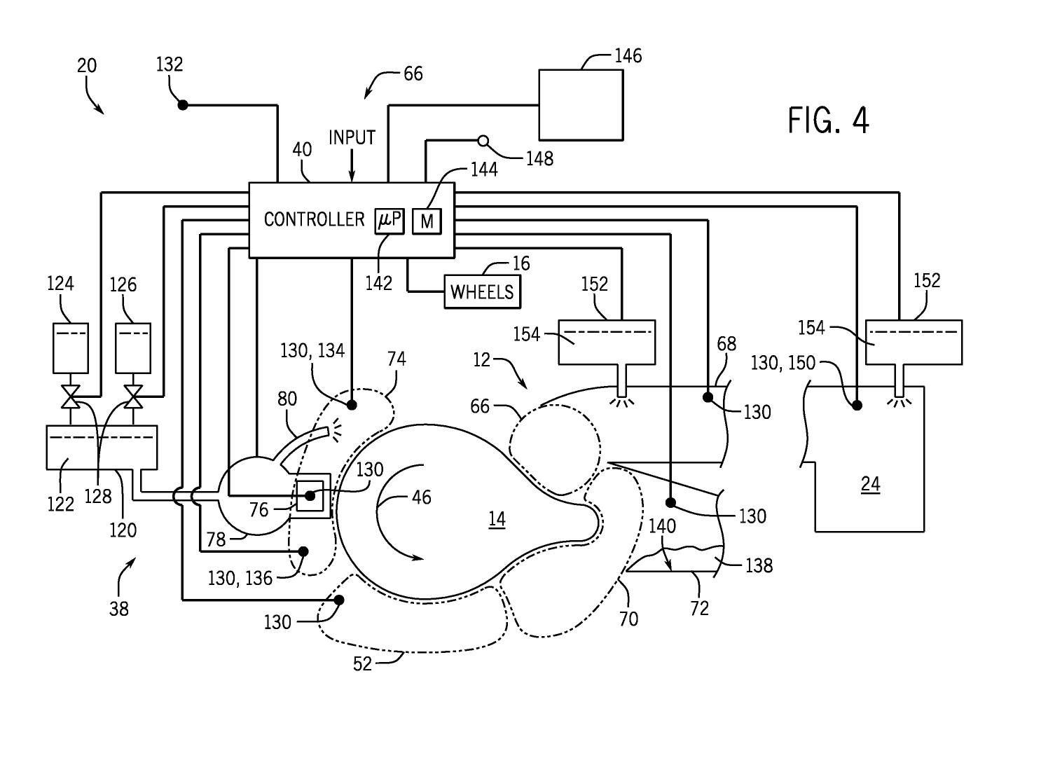

FIG. 3 is a cross-section of the drum 12 of FIG. 2, taken along line 3-3. For conciseness, the embodiments discussed below and illustrated in FIGS. 3 and 4 describe portions of a cotton harvester. However, presently contemplated embodiments are not limited to cotton harvesters, and include moistener systems 38 for other agricultural equipment (e.g., corn head, grain combine, and so forth). As may be appreciated, the moistener system 38 and controller 40 described herein may be utilized with harvesters for other crops (e.g., wheat, corn, sugar cane, etc.). Each drum 12 may have one or more rotors 14 (e.g., 2, 3, 4, 5, or 6 rotors), each of which is configured to remove cotton from bolls in a respective row of cotton plants as the harvester 10 travels across the field. While one drum 12 is described herein, each drum 12 of the harvester 10 may have the same components and features of the drum 12 shown in FIG. 3. The drum 12 has the front rotor 28 and the rear rotor 30 spaced apart along the direction of travel 22. The front rotor 28 and the rear rotor 30 may be on the same or opposite sides of a crop passage 26.

Each rotor 14 has spindle bars 33 that rotate about the axis 34 to remove the harvested good (e.g., cotton) from the crops in the crop passage 26. Each spindle bar 33 has a column of spindles 32 that rotate along their respective axes as shown by arrow 44. The rotor 14 moves the spindle bars 33 along the cam path into the crop passage 26. In the crop passage 26, the rotating spindles 32 interact with crop and remove the cotton from the crop. The cotton may be wound about the spindles 32. In the illustrated embodiment, the spindle bars 33 revolve about the respective rotor 14 in a non-circular (e.g., tear drop, elliptical) cam path. In some embodiments, the spindle bars 33 revolve in a substantially circular path about axis 34. Each spindle 32 may rotate as shown by arrow 44 to wind the cotton about the spindle 32. The spindle bars 33 revolve around the first rotor 28 in a first direction 46, and around the second rotor 30 in a second direction 48 when the rotors 28, 30 are on opposite sides of the crop passage 26. In embodiments where the first rotor 28 and the second rotor 30 are on the same side of the crop passage 26, the spindle bars 33 may revolve around the first and second rotors 28, 30 in the same direction.

In some embodiments, the spindles 32 may be coupled to the rotor 14 via cams or spindle bars 33. The orientation (e.g., angle) of the spindles 32 relative to the axis 34 may change as the spindles 32 revolve about the axis 34 due to the cams or spindle bars 33. For example, the spindle bars 33 are coupled to the rotor 14 so that the spindles 32 enter the crop passage 26 substantially perpendicular to the direction of travel 22. Entering a picking zone 52 in the crop passage 26 at a substantially perpendicular direction 54 enables the spindles 32 to pick (e.g., pierce) the cotton boll as the cotton plant passes through the crop passage 26, rather than sweeping through a cotton plant.

The first rotor 28 revolves the spindles 32 in the first direction 46, and the second rotor 30 revolves the spindles 32 in the second direction 48. Rotor guides 56 direct cotton plants toward the picking zone 52 of the crop passage 26 about each rotor 14. A first doffer 58 rotates in a third direction 60 opposite to the spindles 32 of the first rotor 28 to remove the cotton from the spindles 32, and a second doffer 62 rotates in a fourth direction 64 opposite to the spindles 32 of the second rotor 30 to remove the cotton from the spindles 32. In either orientation of the rotors 14, the spindle bars 33 may rotate through the doffers 36 so that the doffers 36 move in the opposite direction relative to the spindles 32 to remove (e.g., unwind) the cotton from the spindles 32. The cotton is removed from the spindles 32 in a doffing zone 66 by each respective doffer 36. In some embodiments, each doffer 36 has a series of stacked discs 67 with openings to receive the spindles 32. The discs 67 interface with the cotton on the spindles 32 to remove the cotton. The removed cotton is transferred from the doffers 36 to the bin 24 via harvested good outlets 68. In some embodiments, a conveyor 69 may move the cotton through the harvested good outlets 68 to the bin 24 (e.g., baler).

Between the picking zone 52 and the doffing zone 66, the spindles 32 revolve through a discharge zone 70. In the discharge zone 70, a first portion (e.g., foliage) of the agricultural product removed by the spindles 32 in the crop passage 26 is discharged through a discharge outlet 72. The first portion may be actively or passively separated from the agricultural product. For example, the cotton may be wound about the spindles 32, and the first portion (e.g., foliage) may be swept through the picking zone 52. The first portion may be swept (e.g., fall) to the discharge outlet 72 to exit the drum 12 as the rotor 14 rotates about the axis 34. The doffers 36 remove the second portion (e.g., cotton) of the harvested product from the spindles 32. The first portion of the agricultural product may include, but is not limited to stems, branches, foliage, detritus, soil, or other agricultural matter that is not primarily the desired harvested good (e.g., cotton). The first portion may be discharged through the discharge outlet 72 directly to the field and/or to a discharge reservoir.

After the second portion is substantially removed from the spindles 32 in the doffing zone 66, the spindles 32 revolve through a cleaning zone 74. In the cleaning zone 74, the moistener system 38 applies a cleaning solution to the spindles 32 to facilitate removal of sap, cotton, dust, and/or debris accretion from the spindles 32. In some embodiments, the moistener system 38 applies the cleaning solution to the spindles 32 to add moisture to the agricultural product. The moistener system 38 may have one or more moistener pads 76 arranged to wipe the rotating spindles 32 and/or to apply the cleaning solution. The moistener pads 76 may be stacked in rows like the spindles 32, enabling each spindle row to be cleaned by at least one moistener pad 76. The cleaning solution may be stored and/or mixed in a dispensing portion 78. Nozzles 80 apply the cleaning solution to the spindles 32 directly and/or indirectly through the moistener pads 76.

A controller 40 is coupled to the moistener system 38 to control the application of the cleaning solution to the spindles 32. In some embodiments, the cleaning solution includes, but is not limited to, water, a solvent, a soap, a mixture of water and a detergent, or any combination thereof. The controller 40 may adjust the quantity of the cleaning solution applied to the spindles 32 and/or a ratio between the components of the cleaning solution. For example, the controller 40 may increase the quantity of cleaning solution applied to the spindles 32 while the accretion of the harvested good (e.g., cotton) about the spindles 32 and/or rotor 14 is greater than a first accretion threshold. However, applying more cleaning solution may increase the moisture of the agricultural product (e.g., the first portion and/or the second portion). Accordingly, the controller 40 may decrease the quantity of cleaning solution applied to the spindles 32 while the moisture of the agricultural product in one or more zones (e.g., discharge zone 70, doffing zone 66) is greater than a moisture threshold. In addition, the controller 40 may decrease the quantity of cleaning solution applied to the spindles 32 while the accretion of the first portion (e.g., foliage, stems) of the agricultural product in the discharge outlet 72 is greater than a second accretion threshold, while the accretion of the second portion of the agricultural product in the harvested good outlet 68, conveyor 69, or bin 24 is greater than a third accretion threshold, or any combination thereof.

Moreover, the controller 40 may vary the ratio of the detergent to the water to enable the solution to remove more or less agricultural product from the spindles 32 per volume of solution applied. For example, solutions with a high detergent-to-water ratio may effectively clean the spindles 32 while harvesting crops in a field with a relatively high sap content. Accordingly, the controller 40 may control the quantity of the solution applied to the spindles 32 and/or control the composition of the solution applied to the spindles 32 to achieve a desired accretion level about the spindles 32, rotors 14, and/or the outlets 68, 72. In this way, the controller 40 may control a first accretion of harvested good (e.g., cotton) about the spindles 32 and a second accretion of the other agricultural materials in the discharge outlet 72 or harvested good outlet 68 (e.g., conveyor 69) of the harvester 10.

In some embodiments, the zones (e.g., picking zone 52, discharge zone 70, doffing zone 66, cleaning zone 74) discussed herein may overlap and are not necessarily exclusive of one another. For example, the first portion may be discharged from the spindles 32 in the picking zone 52, the doffing zone 66, or the cleaning zone 74. In some embodiments, the picking zone 52, the discharge zone 70, and the doffing zone 66 overlap at least in part. Collectively, the zones at least partially surround the rotors 14.

FIG. 4 is a block diagram of an embodiment of a drum 12 of the harvester 10 of FIG. 1, having the controller 40 coupled to the moistener system 38. The controller 40 controls the distribution and/or composition of the cleaning solution applied to the spindles 32 in the cleaning zone 74. One or more mixing portions 120 of the moistener system 38 distribute cleaning solution 122 to the dispensing portions 78. In some embodiments, one mixing portion 120 of the harvester 10 distributes the cleaning solution 122 to the dispensing portions 78 of each rotor 14. Alternatively, each rotor 14 or each drum 12 may have a mixing portion 120 to distribute a desired quantity and/or composition of cleaning solution 122 as determined by the controller 40. The controller 40 controls the quantity of the cleaning solution 122 applied to the spindles 32 of each rotor 14 through the nozzles 80 and/or the moistener pads 76. The controller 40 may control the composition of the cleaning solution 122 by controlling the ratio between a first liquid 124 (e.g., water) and a second liquid 126 (e.g., detergent) of the cleaning solution 122 via valves 128.

The moistener system 38 may utilize one or more sensors 130 to provide feedback signals to the controller 40 based at least in part on a sensed moisture and/or a sensed accretion at various points within the drum 12 or harvester 10. In some embodiments, the front rotor 28 and the rear rotor 30 may each have one or more sensors 130 to provide feedback signals to the controller 40. The one or more sensors 130 may include, but are not limited to moisture sensors, optical sensors, and temperature sensors. In some embodiments, a moisture sensor 130 may transmit an electrical pulse through the agricultural product to determine the moisture level of the agricultural product. For example, the moisture sensor 130 may sense a change in resistance or capacitance. In some embodiments, a moisture sensor 130 may include a hygrometer. The moisture of the crops in the field may change throughout a harvesting session because of dew formation and evaporation, field conditions (e.g., proximity to water, elevation of the field, time elapsed since prior irrigation), weather, or any combination thereof. Moisture sensors (e.g., humidity sensors) in the picking zone 52 may sense moisture of the crops. Moisture sensors in the discharge zone 70 and/or the discharge outlet 72 may sense moisture of the first portion (e.g., foliage, debris, detritus) of the agricultural product. Moisture sensors in the doffing zone 66, the harvested good outlet 68, and/or the bin 24 may sense moisture of the second portion (e.g., harvested good, cotton) of the agricultural product. Moisture sensors in the cleaning zone 74 may sense moisture on the spindles 32 or on the moistener pads 76. In some embodiments, an external moisture sensor 132 (e.g., humidity sensor) senses the humidity of the external environment 20 about the harvester 10. The moistener system 38 may include a moisture sensor in the picking zone 52, in the discharge zone 70, in the discharge outlet 72, in the doffing zone 66, in the harvested good outlet 68, in the bin 24, in the cleaning zone 74, in the moistener pads 76, in the external environment 20, or any combination thereof.

An optical sensor may sense an accretion by detecting a change in color, brightness, reflectivity, and/or emissivity of a surface proximate to the optical sensor. For example, an optical sensor may sense a first accretion about one or more spindles 32 or rotors 14 based at least in part on a decrease in reflectivity of the spindles 32 (the spindles 32 may be formed from a substantially reflective material, such as aluminum, stainless steel, etc.). The controller 40 may control the quantity and/or the concentration of the cleaning solution 122 based at least in part on differences between feedback signals from a first optical sensor 134 in the cleaning zone 74 and a second optical sensor 136 in the cleaning zone 74. An optical sensor in an outlet (e.g., harvested good outlet 68, discharge outlet 72) may sense a second accretion 138 of the agricultural product (e.g., harvested good, other agricultural material) on an opposing surface 140 because the second accretion 138 is of a different color, brightness, reflectivity, and/or emissivity than the opposing surface 140. In some embodiments, an optical sensor may sense changes in the distance between the optical sensor and the opposing surface 140. In some embodiments, the moistener system 38 includes an optical sensor in the discharge outlet 72, in the harvested good outlet 68, in the bin 24, in the cleaning zone 74, or any combination thereof.

The moistener system 38 may utilize feedback signals from a moisture sensor, an optical sensor, or any combination thereof to control the application of the cleaning solution 122. As discussed above, the locations of the sensors 130 of the moistener system 38 (e.g., moisture sensors, optical sensors) may include, but are not limited to, the picking zone 52, the discharge zone 70, the discharge outlet 72, the doffing zone 66, the harvested good outlet 68, the cleaning zone 74, the bin 24, the external environment 20, or any combination thereof. In some embodiments, each drum 12 may include a separate controller 40 and sensors 130 to control the application of the cleaning solution 122 for the respective drum 12. In some embodiments, the controller 40 (e.g., shared controller) utilizes feedback signals from sensors 130 arranged in multiple drums 12 to control the application of the cleaning solution 122 in the respective drums 12. Moreover, the sensors 130 of the moistener system 38 may be arranged in one or more drums 12, and/or associated with one or more rotors 14. Arranging the sensors 130 in relatively few drums 12 (e.g., 1, 2, or 3 drums) may decrease costs and complexity of the moistener system 38. Arranging the sensors 130 in more drums 12 (e.g., 4, 5, 6, 7, 8, or more) may enable the controller 40 to apply the cleaning solution 122 differentially among the drums 12 in response to differences in sensed moisture and/or sensed accretions within the drums 12. Similarly, in some embodiments, the rotors 14 of each drum 12 may have separate sets of one or more sensors 130 to enable differential application of the cleaning solution 122. In some embodiments, the controller 40 may control the moistener systems 38 for multiple rotors 14 across one or more drums 12 based at least in part on one or more sensors 130 that are arranged at locations about the front rotor 28.

The controller 40 determines the appropriate quantity and/or concentration of the cleaning solution 122 to apply to the spindles 32 based at least in part on feedback signals received from the one or more sensors 130. A processor 142 of the controller 40 determines a moisture level and/or an accretion level based at least in part on the one or more feedback signals from the sensors 130. The controller 40 compares the determined moisture level to a moisture threshold and/or compares the determined accretion level to an accretion threshold. The thresholds may be stored in a memory 144 and may be based at least in part on preset values, operator input values, or operator modified values. In some embodiments, the moisture threshold includes a range of desired moistures between a minimum moisture value and a maximum moisture value (e.g., approximately 3 to 15 percent, or approximately 5 to 12 percent moisture) The moisture threshold may vary based at least in part on the sensor location. For example, the moisture threshold for the harvested good outlet 68 may be a lower value and/or a more narrow range than the moisture threshold in the picking zone 52. The accretion threshold may be a maximum accretion value (e.g., approximately 1, 2, 3, 4, 5, 6, 7, 8, 9, or 10 percent blockage of a duct, spindle diameter greater than approximately 1, 2, 3, 4, or 5 percent nominal value). Based on the comparisons, the controller 40 controls the application of the cleaning solution 122 to the spindles 32, thereby controlling the sensed moisture at a location (e.g., adjusting the moisture to be within the range of desired moistures for the location) and/or controlling the sensed accretion to be less than the accretion threshold.

In some embodiments, the controller 40 controls the application of the cleaning solution based at least in part on a harvesting speed. The agricultural product may accrete about the spindles 32 or in outlets 68, 72 in a relationship (e.g., proportional) to the harvesting speed. The controller 40 may determine the harvesting speed based at least in part on a rotational rate of the wheels 16 or the engine speed of the harvester 10. In some embodiments, the controller 40 controls the quantity of the applied cleaning solution 122 proportionally with the harvesting speed. In some embodiments, the controller 40 controls the concentration of the cleaning solution 122 based at least in part on the harvesting speed. For example, the controller 40 may increase the amount of the second liquid 126 (e.g., detergent) per volume of the first liquid 124 (e.g., water) as the harvesting speed increases.

In the illustrated embodiment, the controller 40 is coupled to a display 146 or indicator 148 (e.g., light, switch, speaker) to provide feedback to the operator. For example, the controller 40 may show on the display 146 the sensed moisture at a location (e.g., picking zone 52, doffing zone 66) about the harvester 10, the sensed accretion at the same or a different location about the harvester 10, the current composition of the cleaning solution 122, the current rate of application of the cleaning solution 122 to the spindles 32, or any combination thereof. In some embodiments, the controller 40 determines the moisture of the cotton in the bin 24 from a feedback signal of a bin sensor 150. The controller 40 may compare the moisture of the cotton in the bin 24 to a bin moisture threshold. The controller 40 may reduce the application of the cleaning solution 122 so that the moisture of the cotton in the bin 24 is less than the bin moisture threshold. The controller 40 may notify the operator via the display 146 and/or the indicator 148 if the moisture of the cotton in the bin 24 is greater than the bin moisture threshold. This notification enables the operator to stop harvesting the cotton when the crop is too moist for harvesting and/or storage.

In some embodiments, the controller 40 may estimate the moisture of the cotton in the bin 24 from one or more moisture sensors 130 upstream from the bin 24, such as one or more moisture sensors 130 in the picking zone 52, the harvested good outlet 68, the discharge outlet 72, and/or the external moisture sensor 132. The controller 40 may estimate the moisture of the cotton in the bin 24 based at least in part on the sensed humidity of the external environment 20, the moisture of the agricultural product, and the quantity of cleaning solution applied to the spindles 32.

In other words, the moisture of the product in the bin 24 may be estimated based on the following general relationship:

M_{BIN}=c₁×M_{AMB}+M_{CROP}+c₂×M_{MOISTENER}+M_{INJ}

where M_{BIN} is the moisture of the cotton in the bin 24, M_{AMB} is the moisture of the ambient environment, M_{CROP} is the moisture of the agricultural product (e.g., cotton bolls, foliage, stems, debris), M_{MOISTENER} is the moisture added by the moistener system 38, and M_{INJ} is the moisture added by a liquid injection system 152. The coefficients c₁ and c₂ may be empirically determined by the controller 40 or an external processor and stored in the memory 144. For example, the controller 40 may determine the moisture absorbed by the cotton bolls from the ambient environment 20 and from the cleaning solution applied by the moistener system 38. Accordingly, the controller 40 may estimate the moisture of the cotton in the bin 24 with the above relationship from feedback signals provided by the moisture sensors 130.

In some embodiments, the controller 40 controls the liquid injection system 152 to increase the moisture of the cotton in the bin 24. The liquid injection system 152 injects a liquid 154 (e.g., water) into the harvested good outlet 68 or into the bin 24. In some embodiments, the increased moisture may increase the compaction of the cotton in the bin 24 or baler. As may be appreciated, cotton fibers of bales with a moisture content below the minimum moisture threshold may be too dry (e.g., brittle), and cotton bales with a moisture content above the maximum moisture threshold may be susceptible to microbial and/or fungal activity. The controller 40 controls the moistener system 38 and the liquid injection system 152 to control the moisture of the cotton in the bin 24 such that the moisture is within a desired moisture range. Accordingly, the controller 40 controls the moisture added to the cotton during harvesting by controlling the moistener system 38 and the liquid injection system 152.

The operator may adjust the controller 40 via an interface to adjust the application of the cleaning solution 122 and/or the liquid 154. In some embodiments, the operator may instruct the controller 40 to control the moistener system 38 automatically based at least in part on the feedback signals from the sensors 130. The automatic control by the controller 40 enables the harvested good (e.g., cotton) in the bin 24 to have a substantially consistent moisture level (e.g., within approximately 10 percent of a desired moisture level). In some embodiments, the controller 40 may turn off the moistener system 38 and/or the liquid injection system 152 at certain times, thereby utilizing the cleaning solution 122 and liquid 154 efficiently. For example, the controller 40 may deactivate the moistener system 38 while the rotors 14 are not harvesting the crop. The controller 40 may increase utilization efficiency of the first liquid 124 and the second liquid 126, and may decrease overall waste of the cleaning solution 122. For example, the controller 40 may decrease the quantity of the cleaning solution 122 applied when harvesting a relatively moist portion of a field. In a relatively moist portion of the field, applying less of the cleaning solution 122 may decrease accretions in an outlet 68, 72 or accretions about the spindles 32. Accordingly, decreasing the quantity of the applied cleaning solution 122 in the moist portion of the field increases the utilization efficiency of the cleaning solution.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An agricultural moistener system comprising:
a sensor configured to provide a feedback signal based at least in part on a sensed moisture about a harvester, a sensed accretion of an agricultural product within the harvester, or any combination thereof; and
a controller configured to receive the feedback signal and to control application of a solution to one or more spindles based at least in part on the feedback signal, wherein the solution is configured to reduce a first accretion of the agricultural product about the one or more spindles, a second accretion of the agricultural product in an outlet of the harvester, or any combination thereof, wherein the one or more spindles is configured to harvest the agricultural product from a field, and the outlet is configured to receive the agricultural product from the one or more spindles.

2. The agricultural moistener system of claim 1, wherein the sensor comprises a moisture sensor configured to sense a moisture level of the agricultural product, a humidity of an ambient environment, or any combination thereof.

3. The agricultural moistener system of claim 2, wherein the moisture sensor is configured to transmit an electrical pulse through the agricultural product to determine the moisture level of the agricultural product.

4. The agricultural moistener system of claim 1, wherein the sensor comprises an optical sensor configured to sense the first accretion of the agricultural product about the one or more spindles, the second accretion of the agricultural product in the outlet of the harvester, or any combination thereof.

5. The agricultural moistener system of claim 1, wherein the solution comprises a water portion and a cleaner portion, wherein the controller is configured to control a ratio of the water portion relative to the cleaner portion in the solution based at least in part on the feedback signal.

6. The agricultural moistener system of claim 1, wherein the controller is configured to control a moisture level based at least in part on the feedback signal.

7. The agricultural moistener system of claim 1, wherein the controller is configured to control a quantity of the solution based at least in part on a harvesting speed.

8. An agricultural moistener system comprising:
a sensor configured to provide a feedback signal based at least in part on a sensed moisture about a harvester, a sensed accretion of an agricultural product within the harvester, or any combination thereof;
a mixing portion configured to receive a first liquid and a second liquid, and to dispense a solution comprising a first portion of the first liquid and a second portion of the second liquid; and
a controller configured to receive the feedback signal and to control dispensation of the solution based at least in part on the feedback signal, wherein the solution is configured to reduce a first accretion of a harvested good of the agricultural product about one or more spindles of the harvester, a second accretion of the agricultural product in an outlet of the harvester, or any combination thereof, wherein the one or more spindles is configured to harvest the agricultural product from a field, and the outlet is configured to receive the agricultural product from the one or more spindles.

9. The agricultural moistener system of claim 8, wherein the sensor comprises a moisture sensor, an optical sensor, or any combination thereof.

10. The agricultural moistener system of claim 8, wherein the first liquid comprises a cleaner configured to clean the one or more spindles.

11. The agricultural moistener system of claim 10, wherein the controller is configured to adjust a ratio of the cleaner to the second liquid in the solution based at least in part on an accretion threshold, and to adjust a quantity of the solution based at least in part on a moisture threshold.

12. The agricultural moistener system of claim 8, comprising an indicator configured to provide a notification while the sensed moisture is greater than a moisture threshold.

13. The agricultural moistener system of claim 8, comprising a liquid injection system configured to inject a third liquid into the harvested good, wherein the controller is configured to determine a desired moisture level in the harvested good and to control the liquid injection system to inject a quantity of the third liquid into the harvested good based at least in part on the sensed moisture and the desired moisture level.

14. The agricultural moistener system of claim 8, wherein the controller is configured to control the dispensation of the solution based at least in part on a harvesting speed.

15. A harvester system comprising:
a moistener system comprising:
a sensor configured to provide a feedback signal based at least in part on a sensed moisture of an agricultural product, a sensed accretion of the agricultural product in the harvester system, or any combination thereof;
a plurality of moistener pads configured to apply a solution to a plurality of spindles; and
a controller configured to receive the feedback signal and to control application of the solution to the plurality of moistener pads based at least in part on the feedback signal, wherein the solution is configured to reduce an accretion of the agricultural product; and
a rotor comprising the plurality of spindles, wherein the plurality of spindles is configured to revolve about the rotor and to move through a plurality of zones, the plurality of zones comprising:
a picking zone, in which the plurality of spindles is configured to harvest the agricultural product;
a doffing zone, in which the plurality of spindles is configured to discharge a portion of the agricultural product into an outlet; and
a cleaning zone, in which a moistener system is configured to apply the solution to the plurality of spindles.

16. The harvester system of claim 15, comprising a liquid injection system configured to apply a liquid to the portion of the agricultural product, wherein the controller is configured to control the application of the liquid based at least in part on the feedback signal.

17. The harvester system of claim 15, wherein the sensor comprises a moisture sensor, and the moisture sensor is disposed in the picking zone or the doffing zone.

18. The harvester system of claim 15, wherein the sensor comprises an optical sensor configured to provide the feedback signal based at least in part on a first accretion about the plurality of spindles, a second accretion in the outlet, or any combination thereof.

19. The harvester system of claim 15, comprising a second sensor configured to provide a moisture signal based at least in part on a detected humidity of an ambient environment, wherein the controller is configured to control the application of the solution to the plurality of moistener pads based at least in part on the moisture signal.

20. The harvester system of claim 19, wherein the controller is configured to determine a moisture level of the second portion of the agricultural product from the feedback signal and the moisture signal, wherein the controller is configured to provide a notification while the moisture level is greater than a moisture threshold.
